(19) United States
(12) Patent Application Publication
(10) Pub. No.: US 2018/0177254 A1
(43) Pub. Date: Jun. 28, 2018

(54) METHOD OF EXTRUDING A THERMOPLASTIC POLYMER TO PRODUCE RANDOM COLORATION AND A PRODUCT USING SAME

(71) Applicants: Russell Neuman, Rocky Face, GA (US); Peter Pförtner, Rocky Face, GA (US)

(72) Inventors: Russell Neuman, Rocky Face, GA (US); Peter Pförtner, Rocky Face, GA (US)

(21) Appl. No.: 15/389,391

(22) Filed: Dec. 22, 2016

(51) Int. Cl. A41G 1/00; B29C 47/00

(52) U.S. Cl. CPC A41G 1/009; B29L 2031/731; B29C 47/0004

(57) ABSTRACT

The present invention comprises a method. The method comprises extruding a mixture comprising a plurality of pellets or granules of a first thermoplastic polymer having a first color or shade and a plurality of pellets or granules of a second thermoplastic polymer having a second color or shade. The mixture also comprises an amount of a compatibilizer such that the first thermoplastic polymer and the second thermoplastic polymer do not delaminate when extruded and wherein the second thermoplastic polymer is incompatible with the first thermoplastic polymer and wherein the first color or shade is different from the second color or shade. The present invention also comprises strands, monofilaments, fibers, filaments, yarns, sheets or films made by the foregoing method. The present invention further comprises an artificial turf having a face pile of strands, monofilaments, fibers, filaments or yarns made by the foregoing method.

### FIELD OF THE INVENTION

The present invention generally relates to extruded polymers having a random coloration. The present invention also relates to artificial turf and other articles made from extruded polymers having a random coloration. More particularly, the present invention relates to an artificial turf having a randomly colored pile that has an appearance more similar to natural grass. Specifically, the present invention relates to a method of extruding polymer strands, monofilaments, fibers, yarns or sheets having a random coloration, which strands, monofilaments or yarns are used to make, inter alia, artificial turf having a more natural appearance. The present invention also relates to a method of extruding polymer sheets or films having a random coloration.

### BACKGROUND OF THE INVENTION

Artificial turf has been known since the early 1960s. Artificial turf is a surfacing material used to imitate natural turf grass or as a substitute for natural turf grass. Artificial turf is generally used in areas where natural turf grass cannot grow or in areas where natural turf grass maintenance is impossible, impractical or undesired. Artificial turf is used mainly in sports stadiums, sports arenas and other sport venues, but can also be found on playgrounds and in other spaces, such as landscape applications.

Artificial turf is typically constructed from a primary backing material and a face pile formed on one side. Face pile can be form in the primary backing by tufting or by adhesively attaching a face pile to the primary backing. Currently, the majority of artificial turf manufactured in the U.S. is made by a tufting process. The tufting process forms a cut pile on one side of a primary backing and loop backs on the opposite side by a process well known in the art. The primary backing can be made from a woven or nonwoven fabric of natural or synthetic materials. Synthetic turf is typically made by tufting synthetic strands, monofilaments or yarns into a synthetic primary backing.

After the primary backing is tufted, an adhesive pre-coat can be applied to lock the tufts in the primary backing. Then, a secondary backing can optionally be adhesively attached by applying a coating of adhesive on the side of the primary backing opposite the face pile, contacting the adhesive with the secondary backing and allowing the adhesive to cool or cure. An adhesive frequently used as an adhesive pre-coat or for attaching a secondary backing to a primary backing is polyurethane.

The strands, monofilaments, fibers or yarns used to form the face pile of artificial turf are typically made from polymeric materials, such as nylon or polyethylene. The polymeric strands, monofilaments, fibers or yarns used to make the face pile of artificial turf are typically made by extruding a thermoplastic polymer, or a combination of thermoplastic polymers, through an orifice or nozzle to form a monofilament, strand, fiber or yarn having a round or oval cross-sectional shape. Alternatively, the thermoplastic polymer can be extruded as a film and then the film can be slit into ribbons. After formation by either process, the monofilaments, strands, fibers, yarns or ribbons are stretched to improve their physical properties.

The polymer monofilaments, strands, fibers, yarns or ribbons used for the face pile of artificial turf typically are uniformly colored green to simulate natural grass. However, natural grass does not have a uniform green color. Therefore, most artificial turf does not have a realistic natural grass appearance. In an effort to overcome this problem, two monofilaments have been co-extruded or twisted together wherein one of the monofilaments has one color or shade, such as green, and the other monofilament has another color or shade, such as yellow. This produces a monofilament where one of the monofilaments has one color or shade and the other monofilament has a different color or shade. This produces an artificial turf having an improved appearance compared to artificial turf having a uniform color, but still does not look like natural grass.

It would be desirable to be able to prepare an artificial turf having an improved color that more closely simulates the appearance of natural grass. It would also be desirable to be able to prepare thermoplastic polymer strands, monofilaments, fibers, filaments, yarns, sheets or films that have a random coloration; i.e., strands, monofilaments, ribbons, fibers, filaments, yarns, sheets or films of one color having randomly dispersed therein portions of a different color or shade.

### SUMMARY OF THE INVENTION

The present invention satisfies the foregoing needs by providing an improved artificial turf and an improved system for extruding thermoplastic strands, monofilaments, ribbons, fibers, filaments, yarns, sheets or films.

In one disclosed embodiment, the present invention comprises a method. The method comprises extruding a mixture wherein the mixture comprises a plurality of pellets or granules of a first thermoplastic polymer, wherein the first thermoplastic polymer is uncolored and a plurality of pellets or granules of a thermoplastic polymer color masterbatch having one or more pigments dispersed therein for coloring the first thermoplastic polymer to a first color or shade, wherein the thermoplastic polymer of the color masterbatch is compatible with the first thermoplastic polymer. The mixture also comprises a plurality of pellets or granules of a second thermoplastic polymer having a second color or shade and an amount of a compatibilizer such that the first thermoplastic polymer and the second thermoplastic polymer do not delaminate when extruded and wherein the second thermoplastic polymer is incompatible with the first thermoplastic polymer and wherein the first color or shade is different from the second color or shade

In another disclosed embodiment, the present invention comprises a method. The method comprises extruding a mixture wherein the mixture comprises a plurality of first pellets or granules of a first thermoplastic polymer having a first color or shade and the size of each of the first pellets or granules is greater than or equal to approximately 30 to approximately 60 pellets or granules per gram, wherein the first thermoplastic polymer is polyethylene (PE), low density polyethylene (LDPE), linear low density polyethylene (LLDPE), polypropylene (PP) or polyamide 6 (PA 6). The mixtures also comprises approximately 4% to 10% by weight based on the total weight of the mixture of a plurality of second pellets or granules of a second thermoplastic polymer having a second color or shade and the size of each of the second pellets or granules is approximately 150 to approximately 450 pellets or granules per gram, wherein the second thermoplastic polymer is polyamide, polyethylene terephthalate, polybutylene terephthalate, copolymers thereof or mixture thereof and wherein the second thermoplastic polymer is incompatible with the first thermoplastic polymer and wherein the first color or shade is different from the second color or shade. The mixture further comprises approximately 0.5% to 2% by weight based on the total weight of the mixture of a compatibilizer such that the first and second thermoplastic polymers do not delaminate when extruded.

In yet another disclosed embodiment, the present invention comprises a strand, monofilament, fiber, filament, yarn, sheet or film. The strand, monofilament, fiber, filament, yarn, sheet or film comprises a first thermoplastic polymer having a first color or shade and a second thermoplastic polymer having a second color or shade randomly and discretely dispersed in the first thermoplastic polymer, wherein the second thermoplastic polymer is incompatible with the first thermoplastic polymer and wherein the first color or shade is different from the second color or shade. The strand, monofilament, fiber, filament, yarn, sheet or film also comprises an effective amount of a compatibilizer such that the first and second thermoplastic polymers do not delaminate.

In another disclosed embodiment, the present invention comprises a method. The method comprises extruding a mixture comprising a plurality of pellets or granules of a first thermoplastic polymer having a first color or shade and a plurality of pellets or granules of a second thermoplastic polymer having a second color or shade. The mixture also comprises an amount of a compatibilizer such that the first thermoplastic polymer and the second thermoplastic polymer do not delaminate when extruded and wherein the second thermoplastic polymer is incompatible with the first thermoplastic polymer and wherein the first color or shade is different from the second color or shade.

In still another disclosed embodiment, the present invention comprises a strand, monofilament, fiber, yarn, sheet or film. The strand, monofilament, fiber, filament, yarn, sheet or film comprises a first thermoplastic polymer having a first color or shade and a second thermoplastic polymer having a second color or shade randomly and discretely dispersed in the first thermoplastic polymer, wherein the second thermoplastic polymer is incompatible with the first thermoplastic polymer and wherein the first color or shade is different from the second color or shade. The strand, monofilament, fiber, filament, yarn, sheet or film further comprises an effective amount of a compatibilizer such that the first and second thermoplastic polymers do not delaminate when extruded.

In another disclosed embodiment, the present invention comprises a strand, monofilament, ribbon, fiber, filament, yarn, sheet or film made by any of the foregoing methods.

In a further disclosed embodiment, the present invention comprises an artificial turf comprising a face pile of strands, monofilaments, fibers, filaments or yarns made by any of the foregoing methods.

Accordingly, it is an object of the present invention to provide an improved synthetic turf or carpet.

Another object of the present invention is to provide an improved polymeric strand, monofilament, fiber, filament, yarn, sheet or film.

A further object of the present invention is to provide an improved method for extruding a polymeric strand, monofilament, fiber, filament, yarn, sheet or film.

Another object of the present invention is to provide an extruded polymeric strand, monofilament, fiber, yarn, sheet or film having a randomly dispersed color or shade.

Yet another object of the present invention is to provide an improved system for coloring an extruded polymeric strand, monofilament, fiber, filament, yarn, sheet or film.

A further object of the present invention is to provide an artificial turf having an appearance more like natural grass.

These and other objects, features and advantages of the present invention will become apparent after a review of the following detailed description of the disclosed embodiments and the appended claims.

### DETAILED DESCRIPTION OF THE DISCLOSED EMBODIMENTS

In a disclosed embodiment, the present invention comprises a system for producing randomly colored, extruded thermoplastic polymeric monofilaments, fibers, strands, yarns, texturized yarns (kurled), sheets, films or slit films. This system utilizes a first uncolored thermoplastic polymer, a thermoplastic polymer color masterbatch having one or more pigments dispersed in a thermoplastic polymer for coloring the first thermoplastic polymer to a first color or shade and a second thermoplastic polymer having a second color or shade that is different from the first color or shade. The thermoplastic polymer color masterbatch colors the first thermoplastic polymer to a desired color or shade when the first thermoplastic polymers and the thermoplastic polymer color masterbatch are melted and blended together, such as during extrusion. The thermoplastic carrier polymer of the color masterbatch is compatible with the first thermoplastic polymer; however, the first and second thermoplastic polymers are incompatible. Therefore, the first and second thermoplastic polymers do not blend together to form a third color or shade when melted and mixed together. Instead, the incompatible second thermoplastic polymer remains separate and distinct from the first thermoplastic polymer. Therefore, when the two polymers are blended together, the second thermoplastic polymer is randomly dispersed in the first thermoplastic polymer. Thus, when the mixture is extruded, the extruded article will be predominantly the first color or shade, but will also have randomly dispersed, distinct areas or portions having the second color or shade. As used herein the term “color” includes the absence of any color; i.e., colorless.

The first thermoplastic polymer or host polymer is a thermoplastic polymer that preferably does not include pigments, and, therefore, is uncolored. Thermoplastic polymers that are useful for the first thermoplastic polymer include but are not limited to thermoplastic polymers for artificial turf, compounding thermoplastics, engineering thermoplastics, high temperature thermoplastics and thermoplastic elastomers. Thermoplastic polymers for artificial turf include, but are not limited to, polyethylene (PE), low density polyethylene (LDPE), linear low density polyethylene (LLDPE), polypropylene (PP) or polyamide (PA). Polyethylene has the formula (C₂H₄)ₙ. Low density polyethylene has a density range of approximately 0.91 to 0.94 g/cm³. Linear low density polyethylene is a substantially linear polymer (polyethylene), with significant numbers of short branches, commonly made by copolymerization of ethylene with longer-chain olefins. Linear low-density polyethylene differs structurally from conventional low-density polyethylene (LDPE) because of the absence of long chain branching. Polypropylene has the formula (C₃H₆)ₙ. Polyamide includes, but is not limited to, Nylon and Nylon 6, which is also known as polycaprolactam.

Compounding thermoplastics include, but are not limited to, acrylonitrile butadiene styrene copolymer (ABS), styrene acrylonitrile copolymer (SAN), polystyrene (PS), high density polyethylene (PE HD), ethylene-vinyl acetate (EVA), polylactic acid (PLA), polybutylene terephthalate (PBT), polyethylene terephthalate (PET). Acrylonitrile butadiene styrene copolymer has the formula (C₈H₈)ₙ.(C₄H₆)_{y}.(C₃H₃N)_{z}. Styrene acrylonitrile copolymer has the formula (C₈H₈)ₙ—(C₃H₃N)ₘ. Polystyrene has the formula (C₈H₈)ₙ. Ethylene-vinyl acetate has the formula (C₂H₄)ₙ(C₄H₆O₂)ₘ. Polylactic acid has the formula (C₃H₄O₂)ₙ. Polybutylene terephthalate has the formula (C₁₂H₁₂O₄)ₙ. Polyethylene terephthalate has the formula (C₁₀H₈O₄)ₙ.

Engineering thermoplastics include, but are not limited to, polyamide 11 (PA 11), polyamide 12 (PA 12), polyamide 66 (PA 66), polycarbonate (PC), polymethyl methacrylate (PMMA) or polyoxymethylene (POM). High temperature thermoplastics include, but are not limited to, polyphenylene sulfide (PPS), polysulfone (PSU), polyether ether ketone (PEEK). Thermoplastic elastomers include, but are not limited to, thermoplastic olefin (TPE-O), thermoplastic polyurethane (TPE-U), thermoplastic copolyester elastomer (TPE-C), thermoplastic polyamides (TPE-A) and styrenic block copolymers (TPE-S).

Typically, thermoplastic polymers are colored in one of at least four methods: color masterbatch, liquid color, cube blend and precolored resins. The most commonly used method currently in use to color thermoplastic polymers is by color masterbatch. A color masterbatch comprises concentrated pigments and optional additives dispersed during a heating process in a compatible thermoplastic polymer carrier resin. During extrusion, the color masterbatch is let down at a predefined ratio into the uncolored resin as it is fed into the extruder. The color masterbatch is then melted and blended with the uncolored resin as the materials travel down the barrel of the extruder so that the extruded thermoplastic has a uniform, desired color or shade. The cube blend method comprises a color masterbatch dry blended with uncolored polymer. Precolored resins are polymers that have already been colored to the desired finished color. Precolored resin pellets are ready for extrusion and no additional processing is necessary. The present invention is applicable to all of these methods of coloring thermoplastic polymers.

The thermoplastic polymer color masterbatch preferably includes one or more pigments and optional additives dispersed in a thermoplastic carrier polymer to provide the desired color or shade to the first thermoplastic polymer when the first thermoplastic polymers and the thermoplastic polymer color masterbatch are melted and blended together, such as during extrusion. The preparation of a thermoplastic polymer color masterbatch is a process that is well known in the art. The pigments that can be used in the present invention for the thermoplastic polymer color masterbatch are those that are well known in the art for coloring thermoplastic polymers. The pigments can be organic or inorganic. Some typical pigments used to color thermoplastic polymers include, but are not limited to, phthalocyanine blues and greens, titanium dioxide, zinc oxide, antimony trioxide, iron yellow oxide, red iron oxide, ferric ammonium ferrocyanide, iron blue, chrome yellow, carbon black, aluminum flakes, chromium titanate, bismuth vanadate yellow, zinc ferrite, mixtures thereof and the like. The amount of pigment used in the thermoplastic polymer color masterbatch is that amount that is effective to provide the desired color or shade to the first thermoplastic polymer. The pigments preferably comprise approximately 5% to approximately 80% by weight of the thermoplastic carrier polymer of the color masterbatch; more preferably approximately 20% to approximately 80% by weight; most preferably approximately 20% to approximately 50% by weight. The foregoing ranges of concentrations of components include all of the intermediate values.

The thermoplastic polymer color masterbatch can also include additives that are optionally added to thermoplastic polymers, including thermoplastic polymers used to prepare the face pile of artificial turf. For example, the thermoplastic polymer color masterbatch can optionally include ultraviolet light absorber compounds (UVA), antioxidants (AO), hindered amine light stabilizers (HALS), fillers, antistatic compounds, lubricants, fire retardants, mold release agents, blowing agents, antimicrobials and the like. The amounts of these materials that are added to the extrudable mixture are those amounts that are typically used in the art. Calcium carbonate is a typical material used as an inert filler for thermoplastics. Clays, such as kaolin, quartz and silica flours can also be used as fillers for thermoplastics. Fillers can also be used to change the mechanical properties of the thermoplastic, such as surface finish, water absorption and chemical and weathering resistance. Most thermoplastic polymers react with oxygen, which causes the polymer to lose physical and mechanical properties. Therefore, it is common to add antioxidants to thermoplastics. Antioxidants inhibit the oxidation reaction by combining with free radicals or by reacting with hydroperoxides. Antioxidants suitable for use in the present invention are commercially available and include, but are not limited to, Irgafos 168, Irganox 1098, Irganox 1076, Irganox 1010 available from BASF Corporation, Florham Park, N.J. Primary antioxidants, such as hindered phenolics and secondary amines, are radical scavengers. Hindered phenolic antioxidants include, but are not limited to, butylated hydroxytoluene and 2,6-di-t-butyl-4-methylphenol. Secondary amine antioxidants include, but are not limited to, phosphites and thioesters. The additives are added to the thermoplastic polymer color masterbatch in the same manner as the pigments and in amounts typically used in the art. Ultraviolet light absorber compounds are commercially available and include, but are not limited to, Tinuvin 234, Tinuvin 360, Tinuvin 1577 available from BASF Corporation, Florham Park, N.J. Hindered amine light stabilizers are commercially available and include, but are not limited to, Tinuvin 944, Tinuvin 119, Tinuvin NOR 116 available from BASF Corporation, Florham Park, N.J.

As stated above, the thermoplastic carrier polymer used for the color masterbatch is compatible with the first thermoplastic polymer. As used herein, the term “compatible” means that the first thermoplastic polymer and the thermoplastic carrier polymer used for the color masterbatch when melted and mixed together cause the pigments in color masterbatch to uniformly disperse in the first thermoplastic polymer thereby providing a uniform color or shade to the first thermoplastic polymer. For example, ethylene-vinyl acetate (EVA) and low density polyethylene (LDPE) can be used as the masterbatch carriers polymer for polyolefin host polymers and nylon and polystyrene can be used as the masterbatch carrier polymer for butadiene styrene copolymer (ABS) and styrene acrylonitrile copolymer (SAN). Preferably, when melted the thermoplastic polymer of the color masterbatch is miscible with the first thermoplastic polymer. Preferably, the first thermoplastic polymers and the thermoplastic carrier polymer used for the color masterbatch are made from the same thermoplastic polymer.

It is a novel aspect of the present invention to add a second thermoplastic polymer to the extrudable mixture of the host thermoplastic polymer (first thermoplastic polymer) and the color masterbatch (thermoplastic carrier polymer and pigments). The second thermoplastic polymer contains one or more pigments and optional additives dispersed therein and is prepared in the same manner as the color masterbatch. However, the one or more pigments in the second thermoplastic polymer provide the second thermoplastic polymer with a different color or shade than the color or shade of the host or first thermoplastic polymer. Additionally, the second thermoplastic polymer is incompatible with the first thermoplastic polymer and the thermoplastic carrier polymer used for the color masterbatch. As used herein the term “incompatible” means that the second thermoplastic polymer would delaminate from the first thermoplastic polymer during a melting process. More specifically, the term “incompatible” means that the second thermoplastic polymer and the host or first thermoplastic polymer are not miscible. Thermoplastic polymers may be “incompatible” because one polymer is polar and the other polymer is non-polar, such as non-polar polyolefins and polar polyamides (PA), such as Nylon 6. Incompatible thermoplastic polymers can be incompatible because the host polymer has a lower melting point than the second thermoplastic polymer.

Since the second thermoplastic polymer is incompatible with the host or first thermoplastic polymer, the pigments in the second thermoplastic polymer do not get dispersed in the host or first thermoplastic polymer. Instead, the pigments in the second thermoplastic polymer remain in the second thermoplastic polymer. Therefore, the pigments are present in the second thermoplastic polymer only in an amount sufficient to provide the second thermoplastic polymer with a desired color or shade that is different from the color or shade of the first thermoplastic polymer after melting and mixing with the thermoplastic polymer color masterbatch or the color or shade of a precolored first thermoplastic polymer. The one or more pigments in the second thermoplastic polymer preferably comprise approximately 5% to approximately 80% by weight of the second thermoplastic polymer; more preferably approximately 20% to approximately 80% by weight; most preferably approximately 20% to approximately 50% by weight. The foregoing ranges of concentrations of components include all of the intermediate values.

As stated above, the second thermoplastic polymer is incompatible with the first thermoplastic polymer. Therefore, the second thermoplastic polymer used for the present invention depends on the polymer that is used for the host or first thermoplastic polymer. Generally speaking, the second thermoplastic polymer can be chose from the list of suitable thermoplastic polymers that can be used for the first thermoplastic polymer as long as such thermoplastic polymer is incompatible with whatever thermoplastic polymer is chosen for the first thermoplastic polymer. Second thermoplastic polymers useful in the present invention include, but are not limited to, polyamide, polyethylene terephthalate, polybutylene terephthalate and copolymers thereof. Examples of combinations of a host or first thermoplastic polymer and an incompatible second thermoplastic polymer include, but are not limited to, polypropylene (PP), low density polyethylene (LDPE) and linear low density polyethylene (LLDPE) are all incompatible with polyamides, polyethylene terephthalate (PET), polybutylene terephthalate (PBT) and copolymers thereof; polyamides, such as Nylon 6, are incompatible with polyethylene terephthalate (PET) and copolymers thereof; and polyethylene (PE) is incompatible with polyamides, such as Nylon 6, and copolymers thereof. For artificial turf, a particularly preferred polymer combination for the first and second thermoplastic polymers is polyethylene for the host or first thermoplastic polymer and Nylon 6 for the second thermoplastic polymer.

Since the second thermoplastic polymer is incompatible with the first thermoplastic polymers, it is necessary to add a compatibilizer to the mixture of the two thermoplastic polymers. Thermoplastic polymer compatibilizers are well know in the art and are commercially available. The type of compatibilizer used depends on the particular polymers that must be made compatible. For example, certain compatibilizers are used for combining polar polymer with non-polar polymers. Compatibilizers useful in the present invention include, but are not limited to ethylene-ethyl acrylate (EEA) copolymer; ethylene-methyl acrylate (EMA) copolymer; ethylene-butyl acrylate (EBA) copolymer; acrylic acid modified copolymers; random terpolymers of ethylene, butyl acrylate and maleic anhydride; random terpolymers of ethylene, ethyl acrylate and maleic anhydride; random terpolymers of ethylene, methyl acrylate and glycidyl methacrylate; copolymers of ethylene and glycidyl methacrylate or mixtures thereof. A particularly preferred compatibilizer is a thermoplastic polymer graft modified with maleic anhydride, such as a maleic anhydride modified polyolefin, a maleic anhydride modified polyamide, a maleic anhydride modified polycarbonate and a maleic anhydride modified methyl acrylate copolymer.

The host or first thermoplastic polymer, the thermoplastic polymer color masterbatch, the second thermoplastic polymer containing pigments and optional additives so that the second thermoplastic polymer has a different color or shade and the compatibilizer are all blended together in a conventional mixer to form an extrudable mixture. The first thermoplastic polymer preferably comprises approximately 70% to approximately 99% by weight of the extrudable mixture, more preferably approximately 85% to approximately 95% by weight and most preferably approximately 88% to approximately 92% by weight. The thermoplastic color masterbatch comprises 0% to approximately 20% by weight of the extrudable mixture, more preferably approximately 5% to approximately 15% by weight and most preferably approximately 6% to approximately 10% by weight. The second thermoplastic polymer comprises approximately 0.5% to approximately 4% by weight of the extrudable mixture, more preferably approximately 0.5% to approximately 3% by weight and most preferably approximately 1% to approximately 3% by weight. The compatibilizer comprises approximately 0.5% to approximately 2% by weight of the extrudable mixture, more preferably approximately 1% to approximately 2% by weight. The foregoing ranges of concentrations of components include all of the intermediate values.

The host or first thermoplastic polymer, the thermoplastic polymer color masterbatch and the second thermoplastic polymer are all preferably in the form of extruded pellets or granules. Each of the pellets or granules of the host or first thermoplastic polymer and the thermoplastic polymer color masterbatch preferably has a size greater than or equal to approximately 60 pellets or granules per gram; more preferably approximately 30 to approximately 60 pellets or granules per gram. Each of the pellets or granules of the second thermoplastic polymer preferably has a size greater than or equal to approximately 400 pellets or granules per gram; more preferably approximately 30 to approximately 400 pellets per gram; most preferably approximately 150 to approximately 400 pellets or granules per gram.

The extrudable mixture is extruded through an extruder typically used in the art, such as a single screw extruder. The extrudable mixture is introduced into the extruder from a hopper. The extrudable mixture travels down the length of the extruder barrel due to the rotation of the screws. As the extrudable material travels down the length of the extruder barrel, it is gradually heated and mixed. The heat applied to the barrel of the extruder and the friction associated with the high pressure mixing heats the extrudable mixture to the melting point of the first thermoplastic polymer and the thermoplastic carrier polymer of the color masterbatch. The mixing action of the extruder causes the pigments of the thermoplastic polymer color masterbatch to be uniformly incorporated in the first thermoplastic polymer and the thermoplastic carrier polymer of the color masterbatch. And, since the first thermoplastic polymer and the thermoplastic carrier polymer of the color masterbatch are compatible, the thermoplastic carrier polymer of the color masterbatch is uniformly incorporated in the first thermoplastic polymer. This produces a host thermoplastic polymer of a first desired color or shade. However, the second thermoplastic polymer is incompatible with the first thermoplastic polymer. Therefore, the pigments of the second thermoplastic polymer do not get incorporated in the host or first thermoplastic polymer, but, rather, remain dispersed in the second thermoplastic polymer. When the extrudable mixture is extruded, for example through a nozzle, orifice or slit, the host thermoplastic polymer comprises the majority of the extruded article having the first color or shade and the second thermoplastic polymer produces streaks of the second color or shade randomly distributed in the extruded article. Since the first color or shade is different from the second color or shade, the extruded article is primarily the color or shade of the first color or shade, but has randomly distributed discrete portions of the different second color or shade. By varying the relative sizes of the first and second thermoplastic polymer pellets or granules, different visual effects can be produced in the extruded article. For example, by increasing the size of the pellets or granules of the second thermoplastic polymer, the different colored portions or streaks produced in the extruded article can be increased in size and/or length. Also, by varying the amount of the pellets or granules of the second thermoplastic polymer relative to the amount of the pellets or granules of the first thermoplastic polymer, the number or frequency of the different colored portions or streaks in the extruded article can be increased or decreased. This gives great power and control over the appearance of the extruded article. And, in the case of artificial turf a more natural appearing face pile can be produced. This can be accomplished by using a traditional turf green color for the first thermoplastic polymer and a yellow color for the second thermoplastic polymer. When such an extrudable mixture is extruded to produce a monofilament, it will primarily have a turf green color with randomly distributed streaks of a different color or shade, such as yellow. When such monofilaments are used to form the face pile of an artificial turf, it will have a much more natural grass appearance due to the random, variegated appearance of the monofilaments.

In another disclosed embodiment, it is contemplated that the first thermoplastic polymer and the thermoplastic color masterbatch can be extruded and formed into pellets or granules of the first thermoplastic polymer having a first color or shade. Then, in a separate step, these precolored pellets or granules of the first thermoplastic polymer having a first color or shade can be blended with pellets or granules of the second thermoplastic polymer having a different second color or shade and the mixture extruded. The extruded article can be used to form other articles, such as the face pile of artificial turf.

In another disclosed embodiment, texturized yarns are made out of monofilament or slit film yarns, in a further process, they are texturized (kurled). Texturized yarns are commonly used as thatch pile in landscape products, to simulate grass roots and encapsulate the infill giving artificial turf a better appearance. The thatch pile layer helps with synthetic grass blade recovery while the brown, green or tan color tones break up the synthetic grass color.

It is specifically contemplated that the present invention can be used to make extruded strands, monofilaments, fibers, yarns, sheets or films. The strands, monofilaments, fibers or yarns can be used to make tufted pile carpet products or woven into textile products. Extruded sheets can be slit into ribbons, which can be used as yarns to make tufted or textile products. Also, extruded sheets can be used to make molded articles, such as by vacuum forming. The extrudable mixture of the present invention can also be used to make articles formed by injection molding.

The following examples are illustrative of selected embodiments of the present invention and are not intended to limit the scope of the invention. All percentages are by weight unless otherwise noted.

### Example 1

A conventional monofilament for use as the face pile of artificial turf is prepared from the following formulation shown in Table 1 below:

TABLE 1

| Color Masterbatch Ingredients | Percent by Weight |
|---|---|
| Polyethylene Polymer | 58 |
| Carbon Black (PBK 7) | 5 |
| Nickel Azo Yellow (PY 150) | 6 |
| Zinc Ferrite (PY 119) | 18 |
| Phthalo Green (PG 7) | 2 |
| HALS Package | 10 |
| AO Package | 1 |

The color masterbatch is extruded and formed into pellets having a size of 4 mm×4 mm (approximately 60 pellets per gram). The color masterbatch is designed for an 8% by weight let down. The foregoing color masterbatch is blended with 92% by weight polyethylene resin pellets having a round size having a 4 mm diameter (approximately 60 pellets per gram) to form an extrudable mixture. This extrudable mixture is fed into an extruder and extruded through a nozzle to form a monofilament. The extruded monofilament is quenched in cold water and wound onto a spool. The monofilament is tufted into a synthetic primary backing material to form a face pile of an artificial turf. The artificial turf has a solid turf green face pile. This example is representative of the prior art method of producing artificial turf.

### Example 2

A second thermoplastic polymer is prepared by combining 50% by weight Chrome Titanate (PBr 24) and 50% by weight Nylon 6. This mixture is extruded and formed into pellets having a size of 3 mm×3 mm (approximately 60 pellets per gram). An extrudable mixture of 1% by weight of the second thermoplastic polymer pellets, including the pigment dispersed therein; 8% by weight of the color masterbatch pellets having a size of 4 mm×4 mm (approximately 60 pellets per gram) from Example 1 above; 90% by weight of pellets of polyethylene having a round size of 4 mm diameter (approximately 60 pellets per gram) and 1% by weight of a compatibilizer; i.e., Fusabond® (a maleic anhydride modified polyolefin) available from du Pont de Nemours, Wilmington, Del. The extrudable mixture is fed into an extruder and extruded through a nozzle to form a monofilament. The extruded monofilament is quenched in cold water and wound onto a spool. The monofilament is tufted into a synthetic primary backing material to form a face pile of an artificial turf. The artificial turf has a more natural grass appearance, which is predominantly turf grass green, but also has randomly dispersed relatively small streaks of yellow therein.

### Example 3

A second thermoplastic polymer is prepared by combining 50% by weight Red Iron Oxide (PR 101) and 50% by weight Nylon 6. This mixture is extruded and formed into micro granules having a size of 1.5 mm×1.5 mm (approximately 250 micro granules per gram). An extrudable mixture of 1% by weight of the second thermoplastic polymer (Nylon 6) micro granules, including the pigment dispersed therein; 8% by weight of the color masterbatch (polyethylene) pellets having a size of 4 mm×4 mm (approximately 60 pellets per gram) from Example 1 above; 90% by weight of pellets of polyethylene having a size of 4 mm×4 mm (approximately 50 pellets per gram) and 1% by weight of a compatibilizer; i.e., Elvaloy® (a maleic anhydride modified polyolefin) available from du Pont de Nemours, Wilmington, Del. The extrudable mixture is fed into an extruder and extruded through a nozzle to form a monofilament. The extruded monofilament is quenched in cold water and wound onto a spool. The monofilament is tufted into a synthetic primary backing material to form a face pile of an artificial turf. The artificial turf has a more natural grass appearance, which is predominantly turf grass green, but also has randomly dispersed relatively small streaks of rust red therein.

### Example 4

A color masterbatch is prepared from the following formulation shown in Table 2 below:

TABLE 2

| Color Masterbatch Ingredients | Percent by Weight |
|---|---|
| Polypropylene Polymer | 78.35 |
| Carbon Black (PBK 7) | 0.3 |
| Nickel Azo Yellow (PY 150) | 1.25 |
| Zinc Ferrite (PY 119) | 8.5 |
| Phthalo Green (PG 7) | 0.6 |
| HALS Package | 10 |
| AO Package | 1 |

The color masterbatch is extruded and formed into pellets having a size of 3 mm×3 mm (approximately 70 pellets per gram). The color masterbatch is designed for an 8% by weight let down.

A second thermoplastic polymer is prepared by combining 50% by weight Chrome Titanate (PBr 24) and 50% by weight Nylon 6. This mixture is extruded and formed into micro granules having a size of 1.5 mm×1.5 mm (approximately 250 micro granules per gram). An extrudable mixture of 1% by weight of the second thermoplastic polymer (Nylon 6) micro granules, including the pigment dispersed therein; 8% by weight of the color masterbatch (polypropylene) pellets having a size of 3 mm×3 mm (approximately 60 pellets per gram) from this example; 90% by weight of pellets of polypropylene having a size of 4 mm×4 mm (approximately 70 pellets per gram) and 1% by weight of a compatibilizer; i.e., Orevac® CA100 (a maleic anhydride graft modified polypropylene) available from Arkema, Clear Lake, Tex. The extrudable mixture is fed into an extruder and extruded through a nozzle to form a monofilament. The extruded monofilament is quenched in cold water and wound onto a spool. The monofilament is tufted into a synthetic primary backing material to form a face pile of an artificial turf. The artificial turf has a more natural grass appearance, which is predominantly turf grass green, but also has randomly dispersed relatively small streaks of yellow therein.

### Example 5

A color masterbatch is prepared from the following formulation shown in Table 3 below:

TABLE 3

| Color Masterbatch Ingredients | Percent by Weight |
|---|---|
| Nylon 6 Polymer | 72.35 |
| Titanium Dioxide (PW 6) | 2 |
| Carbon Black (PBK 7) | 0.2 |
| Nickel Azo Yellow (PY 150) | 1.7 |
| Zinc Ferrite (PY 119) | 10.5 |
| Phthalo Green (PG 7) | 1.25 |
| HALS Package | 10 |
| AO Package | 2 |

The color masterbatch is extruded and formed into pellets having a size of 4 mm×4 mm (approximately 50 pellets per gram). The color masterbatch is designed for an 8% by weight let down.

A second thermoplastic polymer is prepared by combining 50% by weight Chrome Titanate (PBr 24) and 50% by weight polyester polymer. This mixture is extruded and formed into micro granules having a size of 1.5 mm×1.5 mm (approximately 200 micro granules per gram). An extrudable mixture of 1% by weight of the second thermoplastic polymer (polyester) micro granules, including the pigment dispersed therein; 8% by weight of the color masterbatch (Nylon 6) pellets having a size of 4 mm×4 mm (approximately 50 pellets per gram) from this example; 90% by weight of pellets of Nylon 6 having a size of 4 mm×4 mm (approximately 50 pellets per gram) and 1% by weight of a compatibilizer; i.e., Orevac® CA100 (a maleic anhydride graft modified polypropylene) available from Arkema, Clear Lake, Tex. The extrudable mixture is fed into an extruder and extruded through a nozzle to form a monofilament. The extruded monofilament is quenched in cold water and wound onto a spool. The monofilament is tufted into a synthetic primary backing material to form a face pile of an artificial turf. The artificial turf has a more natural grass appearance, which is predominantly turf grass green, but also has randomly dispersed relatively small streaks of yellow therein.

### Example 6

A conventional monofilament for use as the face pile of artificial turf is prepared from the following formulation shown in Table 4 below:

TABLE 4

| Color Masterbatch Ingredients | Percent by Weight |
|---|---|
| Polyethylene Polymer | 71.8 |
| Titanium Dioxide (PW 6) | 11 |
| Carbon Black (PBK 7) | 0.2 |
| Zinc Ferrite (PY 119) | 5 |
| HALS Package | 10 |
| AO Package | 2 |

The color masterbatch is extruded and formed into pellets having a size of 4 mm×4 mm (approximately 50 pellets per gram). The color masterbatch is designed for an 8% by weight let down.

A precolored second thermoplastic polymer is prepared from the formulation shown in Table 5 below.

TABLE 5

| Precolored Second Thermoplastic Polymer | Percent by Weight |
|---|---|
| Nylon 6 Polymer | 52.3 |
| Titanium Dioxide (PW 6) | 6.0 |
| Carbon Black (PBK 7) | 0.6 |
| Nickel Azo Yellow (PY 150) | 5.1 |
| Zinc Ferrite (PY 119) | 31.5 |
| Phthalo Green (PG 7) | 4.5 |

The second thermoplastic polymer is prepared as shown in Table 5 by combining multiple pigments with Nylon resin. This mixture is extruded and formed into micro granules having a size of 1.5 mm×1.5 mm (approximately 200 micro granules per gram). An extrudable mixture of 1% by weight of the precolored second thermoplastic polymer (Nylon) micro granules, including the pigment dispersed therein; 8% by weight of the color masterbatch (Polyethylene) pellets having a size of 4 mm×4 mm (approximately 50 pellets per gram) from this example; 90% by weight of pellets of Polyethylene having a size of 4 mm×4 mm (approximately 50 pellets per gram) and 1% by weight of a compatibilizer; i.e., Orevac® CA100 (a maleic anhydride graft modified polypropylene) available from Arkema, Clear Lake, Tex. The extrudable mixture is fed into an extruder and extruded through a nozzle to form a monofilament. The extruded monofilament is quenched in cold water and wound onto a spool. The monofilament is tufted into a synthetic primary backing material to form a face pile of an artificial turf. The artificial turf has a more natural grass appearance, which is predominantly a dark tan color with randomly dispersed relatively small streaks of turf green therein.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. A method comprising extruding a mixture wherein the mixture comprises:
a plurality of pellets or granules of a first thermoplastic polymer;
a plurality of pellets or granules of a color masterbatch comprising a thermoplastic carrier polymer having one or more pigments dispersed therein for coloring the first thermoplastic polymer to a first color or shade, wherein the thermoplastic carrier polymer is compatible with the first thermoplastic polymer;
a plurality of pellets or granules of a second thermoplastic polymer having a second color or shade;
an amount of a compatibilizer such that the first thermoplastic polymer and the second thermoplastic polymer do not delaminate when extruded; and
wherein the second thermoplastic polymer is incompatible with the first thermoplastic polymer and wherein the first color or shade is different from the second color or shade.

2. The method of claim 1, wherein the size of each of the plurality of pellets or granules of the first thermoplastic polymer is greater than or equal to approximately 60 pellets or granules per gram.

3. The method of claim 1, wherein the size of each of the plurality of pellets or granules of the first thermoplastic polymer is approximately 30 to approximately 60 pellets or granules per gram.

4. The method of claim 1, wherein the size of each of the plurality of pellets or granules of the second thermoplastic polymer is greater than or equal to approximately 400 pellets or granules per gram.

5. The method of claim 1, wherein the size of each of the plurality of pellets or granules of the second thermoplastic polymer is approximately 150 to approximately 400 pellets per gram.

6. The method of claim 1, wherein the size of each of the plurality of pellets or granules of the thermoplastic carrier polymer is approximately 30 to approximately 60 pellets or granules per gram.

7. The method of claim 1, wherein the size of each of the plurality of pellets or granules of the first thermoplastic polymer is approximately 30 to approximately 60 pellets or granules per gram and the size of each of the plurality of pellets or granules of the second thermoplastic polymer is approximately 150 to approximately 400 pellets per gram.

8. The method of claim 1, wherein the first and second thermoplastic polymers are made from the same thermoplastic polymer.

9. The method of claim 1, wherein the compatibilizer is a thermoplastic polymer graft modified with maleic anhydride.

10. The method of claim 1, wherein the compatibilizer is ethylene-ethyl acrylate (EEA) copolymer; ethylene-methyl acrylate (EMA) copolymer; ethylene-butyl acrylate (EBA) copolymer; acrylic acid modified copolymers; random terpolymers of ethylene, butyl acrylate and maleic anhydride; random terpolymers of ethylene, ethyl acrylate and maleic anhydride; random terpolymers of ethylene, methyl acrylate and glycidyl methacrylate; copolymers of ethylene and glycidyl methacrylate or mixtures thereof.

11. The method of claim 1, wherein the compatibilizer is a maleic anhydride modified polyolefin, a maleic anhydride modified polyamide or a maleic anhydride modified polycarbonate.

12. The method of claim 1, wherein the first thermoplastic polymer is polyethylene (PE), low density polyethylene (LDPE), linear low density polyethylene (LLDPE), polypropylene (PP), polyamide 6 (PA 6), acrylonitrile butadiene styrene copolymer (ABS), styrene acrylonitrile copolymer (SAN), polystyrene (PS), high density polyethylene (PE HD), ethylene-vinyl acetate (EVA), polylactic acid (PLA), polybutylene terephthalate (PBT), polyethylene terephthalate (PET), polyamide 11 (PA 11), polyamide 12 (PA 12), polyamide 66 (PA 66), polycarbonate (PC), polymethyl methacrylate (PMMA), polyoxymethylene (POM), polyphenylene sulfide (PPS), polysulfone (PSU), polyether ether ketone (PEEK), thermoplastic olefin (TPE-O), thermoplastic polyurethane (TPE-U), thermoplastic copolyester elastomer (TPE-C), thermoplastic polyamides (TPE-A) and styrenic block copolymers (TPE-S).

13. The method of claim 1, wherein the first thermoplastic polymer is polyethylene (PE), low density polyethylene (LDPE), linear low density polyethylene (LLDPE), polypropylene (PP) or polyamide 6 (PA 6).

14. The method of claim 1, wherein the second thermoplastic polymer is polyamide, polyethylene terephthalate, polybutylene terephthalate and copolymers thereof.

15. The method of claim 1, wherein the compatibilizer comprises approximately 0.5% to approximately 2% by weight of the mixture.

16. The method of claim 1, wherein the plurality of pellets or granules of the second thermoplastic polymer comprise approximately 0.5% to approximately 4% by weight of the mixture.

17. The method of claim 1, wherein the plurality of pellets or granules of the thermoplastic carrier polymer of the color masterbatch comprise approximately 5% to approximately 80% by weight of one or more pigments.

18. The method of claim 1, wherein the plurality of pellets or granules of the second thermoplastic polymer comprise approximately 5% to approximately 80% by weight of one or more pigments.

19. A method comprising extruding a mixture wherein the mixture comprises:
a plurality of first pellets or granules of a first thermoplastic polymer having a first color or shade and the size of each of the plurality of first pellets or granules is to approximately 30 to approximately 60 pellets or granules per gram, wherein the first thermoplastic polymer is polyethylene (PE), low density polyethylene (LDPE), linear low density polyethylene (LLDPE), polypropylene (PP) or polyamide 6 (PA 6);
approximately 0.5% to 4% by weight based on the total weight of the mixture of a plurality of second pellets or granules of a second thermoplastic polymer having a second color or shade and the size of each of the plurality of second pellets or granules is approximately 150 to approximately 450 pellets or granules per gram, wherein the second thermoplastic polymer is polyamide, polyethylene terephthalate, polybutylene terephthalate, copolymers thereof and wherein the second thermoplastic polymer is incompatible with the first thermoplastic polymer and wherein the first color or shade is different from the second color or shade; and
approximately 0.5% to 2% by weight based on the total weight of the mixture of a compatibilizer such that the first and second thermoplastic polymers do not delaminate when extruded.

20. The method of claim 19, wherein the first thermoplastic polymer is polyethylene, the second thermoplastic polymer is nylon and the compatibilizer is a maleic anhydride modified polyolefin.

21. The method of claim 20, wherein;
the first pellets comprise approximately 20% to approximately 100% by weight polyethylene and 0% to approximately 80% by weight of one or more pigments; and
the second pellets comprise approximately 20% to approximately 95% by weight nylon and 5% to 80% by weight of one or more pigments.

22. A strand, monofilament, fiber, filament, yarn, sheet or film made by the method of claim 1.

23. A strand, monofilament, fiber, filament, yarn, sheet or film made by the method of claim 19.

24. An artificial turf comprising a face pile of strands, monofilaments, fibers or yarns made by the method of claim 1.

25. An artificial turf comprising a face pile of strands, monofilaments, fibers or yarns made by the method of claim 19.

26. An artificial turf comprising thatch pile of strands, monofilaments, fibers or tape made by the method of claim 1.

27. An artificial turf comprising thatch pile of strands, monofilaments, fibers or tape made by the method of claim 19.

28. A method comprising extruding a mixture wherein the mixture comprises:
a plurality of pellets or granules of a first thermoplastic polymer having a first color or shade;
a plurality of pellets or granules of a second thermoplastic polymer having a second color or shade;
an amount of a compatibilizer such that the first thermoplastic polymer and the second thermoplastic polymer do not delaminate when extruded; and
wherein the second thermoplastic polymer is incompatible with the first thermoplastic polymer and wherein the first color or shade is different from the second color or shade.

29. The method of claim 28, wherein the first thermoplastic polymer is polyethylene and the second thermoplastic polymer is nylon.

30. A monofilament made by the method of claim 28.

31. An artificial turf having a face pile tufted into a synthetic primary backing material, wherein the face pile is made from the monofilament of claim 30.

32. A strand, monofilament, fiber, filament, yarn, sheet or film comprising:
a first thermoplastic polymer having a first color or shade;
a second thermoplastic polymer having a second color or shade randomly dispersed in the first thermoplastic polymer, wherein the second thermoplastic polymer is incompatible with the first thermoplastic polymer and wherein the first color or shade is different from the second color or shade; and
an effective amount of a compatibilizer such that the first and second thermoplastic polymers do not delaminate.

33. The strand, monofilament, fiber, filament, yarn, sheet or film of claim 33, wherein the first thermoplastic polymer is polyethylene and the second thermoplastic polymer is nylon.
